(19) United States
(12) Patent Application Publication
(10) Pub. No.: US 2003/0087161 A1
(43) Pub. Date: May 8, 2003

(54) Non-aqueous electrochemical cell

(76) Inventor: Martin Topsoe, Vejle (DK)

Correspondence Address: DARBY & DARBY P.C., P. O. BOX 5257, NEW YORK, NY, 10150-5257, US

(21) Appl. No.: 10/168,470

(22) PCT Filed: Dec. 15, 2000
(86) PCT No.: PCT/EP00/13179

(30) Foreign Application Priority Data
Dec. 15, 1999 (GB) 9929698.0

(51) Int. Cl. H01M 10/40; H01M 10/50; H01M 2/02; H01M 4/58; H01M 4/50; H01M 4/52

(52) U.S. Cl. 429/330; 429/200; 429/62; 429/331; 429/176; 29/623.1; 429/338; 429/332; 429/231.4; 429/231.1; 429/223; 429/224; 429/231.3

(57) ABSTRACT

The invention relates to non-aqueous electrochemical cell comprising: a first electrode and a second counterelectrode each capable of reversibly incorporating an alkali metal, preferably lithium; an alkali metal incorporated into at least one of said electrodes; and an electrolyte comprising at least one salt of the alkali metal and a non-aqueous solvent; wherein the said salt is capable of generating HF in the presence of water and the cell includes at least one component, such as a temperature sensitive separator, which precludes complete removal of residual water from the cell, and wherein the cell includes sufficient of an unsaturated cyclic carbonate to reduce the concentration of HF formed by reaction of the electrolyte salt with the residual water.

The present invention relates to a non-aqueous electrochemical cell. More particularly the invention relates to a secondary electrochemical cell of the kind which comprises a first electrode and a second counterelectrode, each capable of reversibly incorporating an alkali metal, more particularly lithium, an alkali metal incorporated in at least one of said electrodes and an electrolyte comprising at least one salt of the alkali metal and a non-aqueous solvent.

U.S. Pat. No. 3,871,915 (Brych assigned to SAFT) relates to an electrochemical storage cell whose negative electrode contains an alkali metal, preferably lithium, whose positive electrode may be copper oxide or silver chromate containing mixtures and whose electrolyte has as its solvent a mixture of a cyclic ether and a cyclic ester, the cyclic ester being an unsaturated cyclic ester preferably vinylene carbonate.

EP-A-0 490 048 (Sanyo Electric Co. Ltd.) relates to a non-aqueous electrolyte cell comprising a positive electrode, a negative electrode, and an electrolyte consisting of a solute and an organic solvent, wherein the solvent is a mixture of a cyclic carbonate and a non-cyclic carbonate. The examples use only ethylene carbonate or propylene carbonate as the cyclic carbonate but it is stated that other cyclic carbonates such as butylene carbonate and vinylene carbonate may also be employed.

U.S. Pat. No. 5,626,981 (Simon et al assigned to SAFT) relates to a rechargeable lithium electrochemical cell comprising an anode containing a carbon-containing material with a degree of crystallinity which is greater than 0.8 and an electrolyte comprising a lithium salt and a mixture of at least two aprotic solvents, of which the first solvent has a high dielectric constant and the second solvent has a low viscosity. The electrolyte further contains a soluble compound of the same type as one of the said solvents and which contains at least one unsaturated bond. For example the solvent mixture may contain propylene carbonate, ethylene carbonate and dimethyl carbonate with the addition of vinylene carbonate as the unsaturated compound. The unsaturated compound is added to form a passivation layer on the anode to prevent reaction of other solvents with the carbon.

U.S. Pat. No. 5,712,059 (Barker et al assigned to Valence Technology, Inc.) relates to a battery which comprises a first electrode, and a counter electrode which forms an electrochemical couple with the first electrode, and an electrolyte. The first electrode comprises graphite particles and the electrolyte comprises a solvent mixture and a solute. The solvent mixture comprises vinylene carbonate or substituted derivatives thereof and propylene carbonate. The specification states that the vinylene carbonate is needed to moderate the tendency of the propylene carbonate to attack carbonaceous active materials.

Jehoulet et al, Electrochemical Society Proceedings, volume 97-18, 974-981 investigated the influence of the solvent composition on the passivation mechanism of the carbon electrode in lithium-ion prismatic cells. They report that the use of an additive such as vinylene carbonate drastically decreases the gas evolution during the passivation.

Many of the alkali metal salts used in the electrolytes of non-aqueous secondary electrochemical cells contain fluorine and are capable of reacting with any water in the cell to produce HF under the conditions encountered in the cell. The detrimental effects of HF in lithium ion cells based on LiMn₂O₄ as the cathode active material and carbon as the anode active material, for example, are described by Blyr et al, J. Electrochem. Soc., 145(1), 194-209 (1998). Essentially, trace amounts of HF and trace amounts of water lead to corrosion of the spinel material, especially at 55° C. and above, which causes manganese plating on the anode. HF and water also cause precipitation of solid lithium compounds on the anode leading to increased permanent capacity loss.

For this reason, non-aqueous secondary electrochemical cells tend to be highly moisture sensitive and during their manufacture the preassembled cell, i.e. the cell before adding the electrolyte, is generally dried by heating to a temperature which is sufficient to drive out all traces of residual moisture. Such temperatures tend to be in excess of 90° C., preferably in excess of 95° C. This presents a problem in cases where the preassembled call (cell precursor) includes one or more components which preclude complete removal of residual water. For example the cell may include a temperature sensitive element which limits the temperature at which the cell can be dried.

Safety in secondary cells such as lithium ion cells is of paramount importance and certain unusual circumstances involving mistreatment or malfunction of the cell can cause the cell to overheat. Accordingly, it is now often required that such cells include a so-called shut down separator in their construction. A shut-down separator is a separator, i.e. an element interposed between the two electrodes, which includes a temperature sensitive layer. If the temperature in the cell exceeds a given temperature (which is regarded as the safe operating temperature of the cell) then the temperature sensitive layer loses its ionic conductivity thereby effectively shutting down the cell. This prevents any further overheating which could lead to thermal runaway and a potentially dangerous situation. However, it is self-evident that the inclusion of a temperature sensitive layer in the battery precursor limits the temperature at which it can be dried to those temperatures which can be tolerated by the temperature sensitive layer.

Secondary calls may include other elements which limit the temperature to which they may be exposed and examples of such elements include temperature sensitive packaging materials, for example soft packaging material, in particular packaging material provided with a sealing material such as an ethylene acrylic acid copolymer.

The present invention is directed towards solution of the problem of non-aqueous secondary electrochemical cells where it is not possible to remove all traces of residual water during the manufacturing process. It has surprisingly been found that inclusion of an unsaturated cyclic carbonate in the cell in such circumstances has a beneficial effect on the properties of the cell.

According to one aspect, the present invention provides a non-aqueous electrochemical cell comprising:

a first electrode and a second counterelectrode each capable of reversibly incorporating an alkali metal;

an alkali metal incorporated into at least one of said electrodes; and

an electrolyte comprising at least one salt of the alkali metal and a non-aqueous solvent; wherein the said salt is capable of generating HF in the presence of water and the cell includes at least one component which precludes complete removal of residual water from the cell,

characterised in that the cell includes sufficient of an unsaturated cyclic carbonate to reduce the concentration of HF formed by reaction of the electrolyte salt with the residual water.

According to another aspect, the present invention provides a non-aqueous electrochemical cell comprising:

a first electrode and a second counterelectrode each capable of reversibly incorporating an alkali metal;

an alkali metal incorporated into at least one of said electrodes;

an electrolyte comprising at least one salt of the alkali metal and a non-aqueous solvent; and

a temperature sensitive element which limits the temperature to which the cell can be exposed during manufacture to below 95° C.,

characterised in that the cell includes an unsaturated cyclic carbonate.

According to a further aspect, the present invention provides the use of an unsaturated cyclic carbonate to reduce the concentration of HF generated by reaction of electrolyte salt with residual water in a non-aqueous electrochemical cell comprising a first electrode and a second counterelectrode each capable of reversibly incorporating an alkali metal, an alkali metal incorporated into at least one of said electrodes and an electrolyte comprising at least one salt of the alkali metal and a non-aqueous solvent.

According to a still further aspect, the present invention provides method of manufacturing a non-aqueous electrochemical cell, said cell comprising:

a first electrode and a second counterelectrode each capable of reversibly incorporating an alkali metal;

a cell housing containing said electrodes;

an alkali metal incorporated into at least one of said electrodes;

an electrolyte comprising at least one salt of the alkali metal and a non-aqueous solvent; and

an unsaturated cyclic carbonate;

said method comprising the steps of:

(a) assembling said electrodes in said cell housing to form a cell precursor;

(b) drying said cell precursor at a temperature of 95° C. or less;

(c) filling said electrolyte into said cell precursor; and

(d) sealing said housing and initialising said cell.

The alkali metal incorporated into the one or both of the electrodes in the cell according to the invention is preferably lithium.

The unsaturated cyclic carbonate includes vinylene carbonate and compounds which can be regarded as derivatives of vinylene carbonate. Preferably the unsaturated cyclic carbonate is a compound of formula (I):

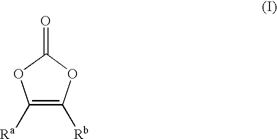

wherein R^{a} and R^{b}, which may be the same or different, are each selected from hydrogen, halogen, amino, substituted amino, amide, carbonate, straight or branched chain saturated or unsaturated aliphatic groups, cyclic aliphatic groups, aromatic groups or heterocyclic groups, where the groups R^{a} and/or R^{b} are carbon containing groups these groups being optionally substituted. The groups R^{a} and R^{b} may be substituted by any substituent or combination of substituents which does not adversely affect the properties of the compound for use in its intended purpose according to the present invention. One example of a suitable substituent is halogen.

As used herein, the term halogen means fluorine, chlorine, bromine or iodine, preferably fluorine or chlorine. Where R^{a} and/or R^{b} is a carbon containing group it preferably contains up to 10 carbon atoms, more preferably up to 6 carbon atoms.

Particularly preferred compounds according to formula (I) are:

R^{a}═R^{b}═H (vinylene carbonate); R^{a}═R^{b}=phenyl (diphenyl vinylene carbonate).

The unsaturated cyclic carbonate may be incorporated into the cell in any convenient manner. Thus the compound may be included as part of the solvent for the electrolyte or may be added to the electrolyte before this is filled into the cell. Alternatively, the unsaturated cyclic carbonate may be added to at least one of the electrode pastes for example by being added to the binder, prior to coating on the current collector. As a further alternative, one or both of the electrodes may be coated with a composition containing the unsaturated cyclic carbonate.

The cell according to the invention preferably contains 0.05 to 20% by volume of the unsaturated cyclic carbonate based on the electrolyte solvent, more preferably 0.5 to 2% by volume of the unsaturated cyclic carbonate based on the electrolyte solvent.

The component of the non-aqueous electrochemical cell according to the invention which precludes complete removal of residual water may be an element limiting the temperature at which the cell can be dried. According to one embodiment, such an element may be a temperature sensitive separator also referred to as a shut-down separator. Separators are generally included between the electrodes in non-aqueous secondary electrochemical cells to guard against the possibility of short circuits and the requirements for a separator are that it must have sufficient porosity and permeability to allow ionic conductivity whilst being electrically insulating. The separator must also, of course, be chemically inert under the conditions of the cell. As already noted above, a shut-down separator is a separator which adds the property that it is temperature sensitive in the sense that ionic conductivity is lost if the temperature rises above a certain level regarded as the safe operating temperature of the cell. Such a temperature rise can occur in certain situations, for example involving mistreatment or malfunction of the cell and the operation of the shut-down separator prevents further overheating of the cell and the possibility of thermal runaway which is potentially dangerous (risk of fire or explosion).

It is clear that the presence of a temperature sensitive shut-down separator means that a cell precursor cannot be processed at a temperature above the temperature at which the shut-down separator loses its porosity and permeability. However, the effective limit on the maximum temperature at which the cell precursor can be processed may well be lower than this temperature. The reduction in permeability generally come about as a result of a reduction in the size of the pores. A consequential effect of reduction in pore size is crimping of the separator which is, of course, undesirable in a cell and this crimping effect may well start at a temperature which is significantly lower than the temperature at which porosity is lost.

Typical materials for shut-down separators include high density polyethylene (HDPE) and polypropylene (PP), the latter being less effective in shutting down the cell but also less prone to crimping. Shut-down separators may have 2 or more layers for improved properties, for example a 2 layer separator of PP and PE or a 3 layer separator of PP, PE and PP. One example of a suitable shut-down separator is the Tonen E25HHS separator produced by the company Setela which is made of HDPE.

According to another embodiment, the element of the non-aqueous electrochemical cell limiting the temperature to which it can be dried may be temperature sensitive packaging material, for example soft packaging material, such as packaging material provided with a sealing material such as an ethylene acrylic acid copolymer, or a heat sealable plastic comprising polyethylene and polypropylene. An example of a heat sealing material is Surlyn 1652. The melting temperature of any sealing material in the packaging must be well above the drying temperature and the possibility of using a lower drying temperature provides the designer of the cell with much more freedom to chose sealing materials based on sealing properties trather than temperature performance.

The temperature sensitive element may limit the temperature at which the cell can be dried to 95° C. or less, for example to 90° C. or less, more particularly to 60° C. or less.

Where the cell does not include a shut-down separator of the type described above, the cell may incorporate a conventional separator.

The present invention is particularly applicable in the case where the cell includes components which include some moisture and, indeed, application of the invention may enable such components to be used where this would not otherwise be possible. Examples of such components include water based binders for the electrodes which have very good binding properties but whose use may previously have been precluded on account of their water content. Alternatively, the invention may make it possible to use a packaging material containing a small amount of water, for example packaging materials containing nylon.

The electrolyte in the cell according to the present invention generally comprises a solvent or solvent mixture. The choice of solvent depends on a number of factors including the nature of the electrode active materials but the solvent(s) are generally selected from one or more of the following groups:

(a) alicyclic carbonates represented by the following general formula:

—C(═O)—O—CR₁R₂—[CR₃R₄]ₘ—CR₅R₆—O—,

wherein each of R₁, R₂, R₃, R₄, R₅ and R₆ independently represents hydrogen or a C₁-C₄ alkyl group and m is 0 or 1, preferably ethylene carbonate;

(b) aliphatic carbonates represented by the general formula R₇[OC(O)]ₚOR₈, wherein each of R₇ and R₈ independently represents a C₁-C₄ alkyl group, and p is an integer equal to 1 or 2, preferably dimethyl carbonate or diethyl carbonate;

(c) lactones in the form of cyclic esters represented by the general formula:

—C(═O)—CR₉R₁₀—CR₁₁R₁₂—[CR₁₅R₁₆]ᵣ—CR₁₃R₁₄—O—

wherein each of R₉, R₁₀, R₁₁, R₁₂, R₁₃, R₁₄, R₁₅ and R₁₆ independently represents hydrogen or a C₁₋₂ alkyl group and r is 0 or 1, preferably γ-valerolactone or γ-butyrolactone;

(d) esters represented by the formula R₁₇[C(O)]OR₁₈[OR₁₉]ₜ, wherein each of R₁₇, R₁₈ and R₁₉ independently represents hydrogen or a C₁-C₂ alkyl group, and t is 0 or an integer equal to 1 or 2, preferably an acetate, more preferably (2-methoxyethyl)-acetate or ethyl acetate;

(e) glymes represented by the general formula R₂₀O(R₂₁O)ₙR₂₂, in which each of R₂₀ and R₂₂ independently represents a C₁₋₂ alkyl group, R₂₁ is —(CR₂₃R₂₄CR₂₅R₂₆)— wherein each of R₂₃, R₂₄, R₂₅ and R₂₆ independently represents hydrogen or a C₁-C₄ alkyl group, and n is an integer from 2 to 6, preferably 3, R₂₀ and R₂₂ preferably being methyl groups, R₂₃, R₂₄, R₂₅ and R₂₆ preferably being hydrogen or C₁-C₂ alkyl groups, more preferably hydrogen.

Most preferably, the electrolyte solvent contains ethylene carbonate and/or diethyl carbonate. It has been found that the use of the unsaturated cyclic carbonate according to the present invention is particularly advantageous when the solvent also includes a minor proportion, for example up to 15%, preferably 5 to 15%, most preferably about 10% by volume, of propylene carbonate.

Preferably the salt included in the electrolyte is an alkali metal salt or a quaternary ammonium salt of ClO₄—, CF₃SO₃—, AsF₆—, PF₆— or BF₄—, or any mixture of such alkali or ammonium salts, preferably LiAsF₆, LiCF₃SO₃, LiPF₆, LiBF₄, N(Et)₄BF₄ or N(Bu)₄BF₄ or any mixture thereof, more preferably LiPF₆ or LiBF₄. The electrolyte must contain at least one salt capable of generating HF in the presence of water under the conditions in the cell. The salts are preferably present in the electrolyte solvent(s) in a concentration of 0.01M to 2.5M, more preferably 0.1M to 1.5M.

The electrolyte can be liquid or can be immobilised by addition of a suitable polymer. Suitable immobilising polymers include cellulose derivatives and polyvinylpyrrolidone and derivatives thereof.

The positive electrode in the cell according to the invention preferably includes a form of carbon as the electrode active material. A wide variety of carbonaceous materials can be used provided only that the carbonaceous material must be capable of reversibly intercalating alkali metal ions, preferably lithium ions. Examples of such carbonaceous materials include: highly structured, highly crystalline graphites: graphitised cokes; and non-graphitic carbons such as petroleum coke. Preferably the carbon is graphite, for example mesocarbon microbeads. The electrode active material is generally formulated together with a suitable binder, for example a polymer such as a polyvinylidene difluoride, in an organic solvent such as N-methyl pyrollidone, to form an electrode paste. The paste may include other additives such as carbon black. This paste is then coated onto a suitable current collector, for example copper foil.

The positive electrode structure in the cell according to the present invention is based on an alkali metal, preferably lithium, intercalation material as electrode active material. Preferably the electrode active material is a lithium transition metal oxide such as LiCoO₂, LiNiO₂ or LiMn₂O₄. However, in principle any material capable of donating Li⁺ ions can be used. The electrode active material is generally formulated together with a suitable binder, for example a polymer such as a polyacrylate or a polyolefin in an organic solvent such as N-methyl pyrollidone, to form an electrode paste. This paste is then coated onto a suitable current collector, for example aluminium foil.

The cell according to the invention may be made in a conventional manner. Thus the electrodes are generally formed by coating an electrode paste of the appropriate composition onto suitable current collectors. The electrodes, together with any separator to be used, are then assembled into a cell housing to form a cell precursor. The cell precursor is then dried at a temperature determined by the components of the cell but in the case where the cell includes temperature sensitive components the temperature will generally be 95° C. or less. The electrolyte is then filled into the cell precursor which is then provided with a temporary seal and initialised. Following initialisation, the cell is preferably reopened to allow gasses formed during initialisation to vent off and is then permanently sealed.

The invention is illustrated by the following examples in which:

VC=vinylene carbonate

EC=ethylene carbonate

PC=propylene carbonate

DEC=diethyl carbonate.

In the accompanying drawings:

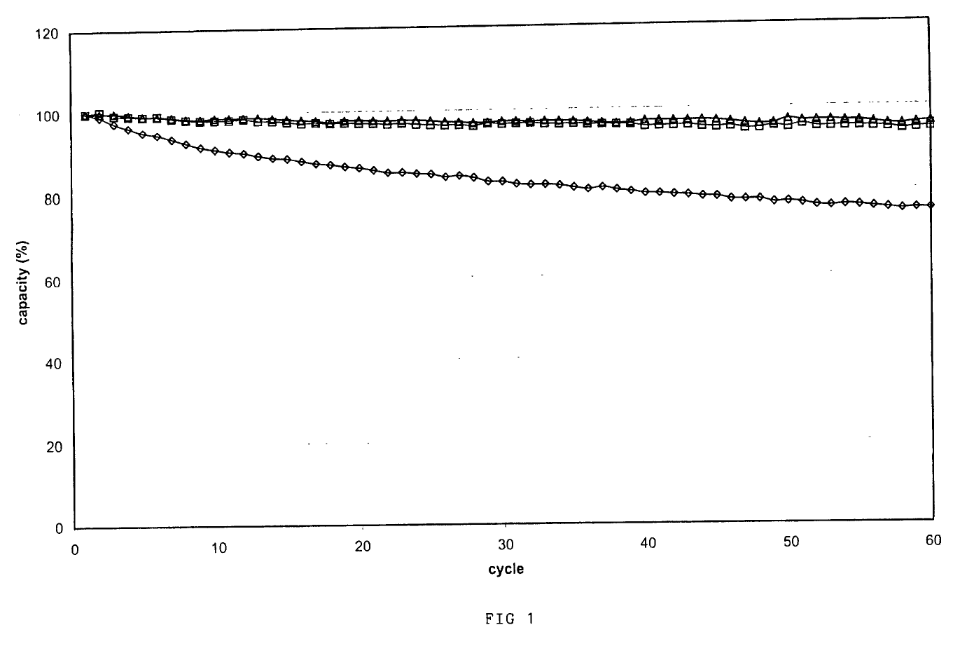

FIG. 1 shows the effect of VC on the cyclability of cells dried at 95° C.; and

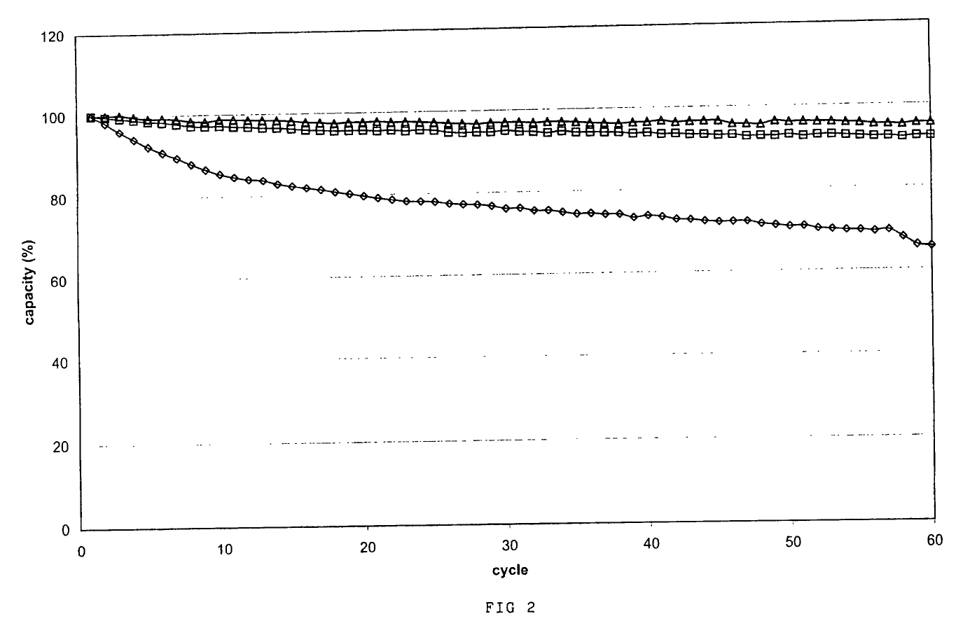

FIG. 2 shows the effect of VC on the cyclability of cells dried at 60° C.

### EXAMPLE 1

The following tests simulated the effect of being unable to dry a lithium ion cell completely by adding a small amount of water to the electrolyte.

The basic electrolyte used was EC/DEC (1:1 by volume) containing 0.6M LiBF₄ and 0.4M LiPF₆ and doped with 0.2 g water to 1000 g electrolyte. The following electrolytes were used:

Electrolytes 1 and 2—basic electrolyte (10 g)

Electrolytes 3 and 4—basic electrolyte+1% by volume VC (1.0 g VC added to 100 g of basic electrolyte)

Electrolytes 5 and 6—basic electrolyte+1% by volume VC+10% by volume PC (1.1 g VC+11.2 g PC added to 100 g of basic electrolyte).

Test 1 (Glass Bottles)

This test was carried out by filling the samples of electrolyte under an argon atmosphere into tightly sealed 100 ml glass bottles and storing them for 1 week at room temperature. The HF and water contents of each bottle were then measured. HF was measured by the standard method of alkimetric titration of the free acid (calculation as HF) and water content was measured. The results are shown in Table 1.

TABLE 1

| | HF content | Average HF | H₂O content | Average H₂O |
|---|---|---|---|---|
| Electrolyte | (ppm) | (ppm) | (ppm) | (ppm) |
| 1 | 337 | 311.0 | 93 | 92.5 |
| 2 | 285 | | 94 | |
| 3 | 264 | 328.0 | 80 | 73.0 |
| 4 | 392 | | 66 | |
| 5 | 248 | 283.5 | 73 | 77.0 |
| 6 | 319 | | 81 | |

Test 2 (Cells)

This test was carried out using lithium ion cells with the following construction:

Anode:

active material: mesocarbon microbeads graphitised at 2800° C. (Osaka Gas)

additional material: carbon black

binder: polyvinylidene difluoride in N-methylpyrrolidone

current collector: copper.

Cathode:

active material: LiCoO₂

binder: polyacrylate and polyethylene in N-methylpyrrolidone

current collector: aluminium foil.

Electrolyte:

Electrolytes 1 to 6 as described above.

Separator:

Tonen E25HHS shut down separator made of HDPE and produced by the company Setela. The cathode, separator and anode were assembled and wound into a “jelly roll” which was then packed into a polymer metal pillow bag to produce a cell precursor. The cell precursor was dried by heating to 60° C. and then allowed to cool to room temperature. The electrolyte was used the day after preparation and 7 g of electrolyte was filled into each cell. The cells bags were closed with a temporary closure and rested at 35° C. for 3 hours before being initialised at room temperature. The bag was then opened and the gas created during initialisation allowed to evaporate before the cell was finally sealed and sent for analysis. HF and water in the electrolyte were measured as above and the results are shown in Table 2

TABLE 2

| Electrolyte No | HF content (ppm) | Average HF (ppm) |
|---|---|---|
| 1 | 41.5 | 41.9 |
| 2 | 42.2 | |
| 3 | 30.7 | 29.5 |
| 4 | 28.2 | |
| 5 | 31.4 | 33.0 |
| 6 | 34.6 | |

### CONCLUSIONS

Addition of VC to the electrolyte did not have any significant effect on HF generation when the electrolyte was stored in sealed glass bottles. Addition of VC (alone or with PC) significantly reduced the amount of HF in the electrolyte of initialised cells. This indicates that the effect of VC is related to initialisation, i.e. the discharging and recharging of the cell.

### EXAMPLE 2

The following tests used the same basic electrolyte as in Example 1 but without the addition of water and including tests in which the cell was dried by heating to 95° C. The same cell was used as in example 1 including the Tonen shut down separator. The results are shown in Table 3.

TABLE 3

| | | | HF | |
|---|---|---|---|---|
| | Electrolyte | Drying | Content | Average HF |
| Cell no | composition | temperature ° C. | (ppm) | (ppm) |
| 1 | basic | 95 | 23.3 | 21.15 |
| 2 | basic | 95 | 19.0 | |
| 3 | basic + 1% VC | 95 | 25.0 | |
| 4 | basic + 1% VC | 95 | | |
| 5 | basic | 60 | 80.1 | 75.45 |
| 6 | basic | 60 | 70.8 | |
| 7 | basic + 1% VC | 60 | 63.5 | 63.85 |
| 8 | basic + 1% VC | 60 | 64.2 | |
| 9 | basic + 1% VC + | 60 | 37.2 | 34.85 |
| | 10% PC | | | |
| 10 | basic + 1% VC + | 60 | 32.5 | |
| | 10% PC | | | |

The conclusion can be drawn that the lowest HF content measured directly after initialisation can be achieved by drying at 95° C. and in this case addition of VC does not have any further effect on initial HF content. In the case of drying at 60° C. and not using any VC, the initial HF content increases more than 3 fold over drying at 95° C. Use of 10 VC reduces the initial HF content by about 15% (which is a significant reduction) but very surprisingly use of VC and PC brings about a reduction of well over 50%.

In the case of the cells heated to 95° C. the Tonen separator had shrunk by about 10%. The separator still allowed passage of ions and its shut down capability probably remained. However, the effect on the separator and doubts about whether it would be completely effective mean that drying at 95° C. could not have been used for commercial production. Furthermore, shrinkage of the Tonen separator by about 10% on heating to 95° C. is highly undesirable since, depending on the cell dimensions and winding scheme, this could lead to short circuits between the electrodes and/or curling of the cell.

### EXAMPLE 3

Tests were carried out to investigate the cycling performance of two groups of three cells each made in the manner described in Example 2. The first group of cells was dried by heating to 95° C. and the second group of cells was dried at 60° C. The three cells in each group had respectively the following electrolyte composition:

basic

basic+1% VC

basic+1% VC+10% PC

i.e. the cells corresponded to those of Example 2 except for the addition of a cell dried at 95° C. with the electrolyte composition basic+1% VC+10% PC. There was no significant difference between the initial capacities of the cells in the sense that all had an initial capacity within the normal range expected for cells of this type. Cycling performance of the cells was tested over 60 charge/discharge cycles with capacity being expressed as a percentage of capacity on the first cycle. The results are shown graphically in FIGS. 1 and 2 of the accompanying drawings with FIG. 1 showing results for the cells dried at 95° C. and FIG. 2 showing results for cells dried at 60° C. In both cases ⋄=basic, □=basic+1% VC, Δ=basic+1% VC+10% PC.

It can be seen from FIGS. 1 and 2 that VC either alone or with PC improves the cycling performance of both cells dried at 60° C. and cells dried at 95° C. This suggests that in both cases the cells may still contain some water in the electrodes and/or the electrolyte which is released and generates HF during the cycling period. The presence of VC protects against water/HF related negative effects and improves cyclability.

1. A non-aqueous electrochemical cell comprising:
a first electrode and a second counterelectrode each capable of reversibly incorporating an alkali metal;
an alkali metal incorporated into at least one of said electrodes; and
an electrolyte comprising at least one salt of the alkali metal and a non-aqueous solvent; wherein the said salt is capable of generating HF in the presence of water and the cell includes at least one component which precludes complete removal of residual water from the cell,
characterised in that the cell includes sufficient of an unsaturated cyclic carbonate to reduce the concentration of HF formed by reaction of the electrolyte salt with the residual water.

2. A non-aqueous electrochemical cell as claimed in claim 1 wherein the unsaturated cyclic carbonate is a compound of formula (I): 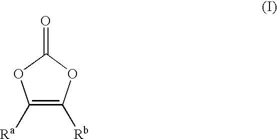
wherein R^{a} and R^{b}, which may be the same or different, are each selected from hydrogen, halogen, amino, substituted amino, amide, carbonate, straight or branched chain saturated or unsaturated aliphatic groups, cyclic aliphatic groups, aromatic groups or heterocyclic groups, where the groups R^{a} and/or R^{b} are carbon containing groups, these groups being optionally substituted.

3. A non-aqueous electrochemical cell as claimed in claim 1 wherein the unsaturated cyclic carbonate is vinylene carbonate.

4. A non-aqueous electrochemical cell as claimed in any of claims 1 to 4 which includes an element limiting the temperature at which the cell can be dried.

5. A non-aqueous electrochemical cell as claimed in claim 4 wherein the element is a temperature sensitive separator.

6. A non-aqueous electrochemical cell as claimed in claim 4 wherein the element is a temperature sensitive packaging material.

7. A non-aqueous electrochemical cell as claimed in any of claims 4 to 7 wherein the element limits the temperature at which the cell can be dried to 95° C. or less.

8. A non-aqueous electrochemical cell as claimed in any of claims 4 to 7 wherein the element limits the temperature at which the cell can be dried to 90° C. or less.

9. A non-aqueous electrochemical cell as claimed in any of claims 4 to 7 wherein the element limits the temperature at which the cell can be dried to 60° C. or less.

10. A non-aqueous electrochemical cell as claimed in any of claims 1 to 9 wherein the cell contains a water based binder.

11. A non-aqueous electrochemical cell as claimed in any of claims 1 to 9 wherein the cell contains a packaging material containing a small amount of water.

12. A non-aqueous electrochemical cell as claimed in claim 11 wherein the packaging material contains nylon.

13. A non-aqueous electrochemical cell as claimed in any of claims 1 to 12 wherein the electrolyte solvent contains ethylene carbonate and/or diethyl carbonate.

14. A non-aqueous electrochemical cell as claimed in any of claims 1 to 13 wherein the electrolyte solvent contains propylene carbonate.

15. A non-aqueous electrochemical cell as claimed in any of claims 1 to 14 wherein the cell contains 0.05 to 20% by volume of the unsaturated cyclic carbonate based on the electrolyte solvent.

16. A non-aqueous electrochemical cell as claimed in any of claims 1 to 14 wherein the cell contains 0.5 to 2% by volume of the unsaturated cyclic carbonate based on the electrolyte solvent.

17. A non-aqueous electrochemical cell as claimed in any of claims 1 to 16 wherein the alkali metal is lithium.

18. A non-aqueous electrochemical cell as claimed in claim 17 wherein the positive electrode includes carbon as electrode active material.

19. A non-aqueous electrochemical cell as claimed in claim 18 wherein the carbon is graphite.

20. A non-aqueous electrochemical cell as claimed in any of claims 17 to 19 wherein the negative electrode material contains a lithium transition metal oxide as electrode active material.

21. A non-aqueous electrochemical cell as claimed in claim 20 wherein the lithium transition metal oxide is LiCoO₂, LiNiO₂ or LiMn₂O₄.

22. A non-aqueous electrochemical cell as claimed in any of claims 1 to 21 wherein the unsaturated cyclic carbonate is added to the electrolyte prior to filling the electrolyte into the cell.

23. A non-aqueous electrochemical cell as claimed in any of claims 1 to 21 wherein the electrodes are formed by coating an electrode paste onto a current collector and the unsaturated cyclic carbonate is added to at least one of the electrode pastes prior to coating on the current collector.

24. A non-aqueous electrochemical cell as claimed in claim 23 wherein the electrode paste contains a binder and the unsaturated cyclic carbonate is added to the binder.

25. A non-aqueous electrochemical cell comprising:
a first electrode and a second counterelectrode each capable of reversibly incorporating an alkali metal;
an alkali metal incorporated into at least one of said electrodes;
an electrolyte comprising at least one salt of the alkali metal and a non-aqueous solvent; and
a temperature sensitive element which limits the temperature to which the cell can be exposed during manufacture to below 95° C.,
characterised in that the cell includes an unsaturated cyclic carbonate.

26. A non-aqueous electrochemical cell as claimed in claim 25 wherein the unsaturated cyclic carbonate is a compound of formula (I): 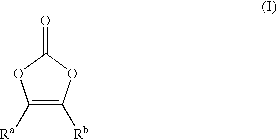
wherein R^{a} and R^{b}, which may be the same or different, are each selected from hydrogen, halogen, amino, substituted amino, amide, carbonate, straight or branched chain saturated or unsaturated aliphatic groups, cyclic aliphatic groups, aromatic groups or heterocyclic groups, where the groups R^{a} and/or R^{b} are carbon containing groups, these groups being optionally substituted.

27. A non-aqueous electrochemical cell as claimed in claim 25 wherein the unsaturated cyclic carbonate is vinylene carbonate.

28. A non-aqueous electrochemical cell as claimed in any of claims 25 to 27 wherein the element limiting the temperature to which the cell can be exposed during manufacture is a temperature sensitive separator.

29. A non-aqueous electrochemical cell as claimed in any of claims 25 to 27 wherein the element limiting the temperature to which the cell can be exposed during manufacture is a temperature sensitive packaging material.

30. A non-aqueous electrochemical cell as claimed in any of claims 25 to 29 wherein the element limits the temperature to which the cell can be exposed to 90° C. or less.

31. A non-aqueous electrochemical cell as claimed in any of claims 25 to 29 wherein the element limits the temperature at which the cell can be exposed to 60° C. or less.

32. A non-aqueous electrochemical cell as claimed in any of claims 25 to 31 wherein the cell contains a water based binder.

33. A non-aqueous electrochemical cell as claimed in any of claims 25 to 32 wherein the cell contains a packaging material containing a small amount of water.

34. A non-aqueous electrochemical cell as claimed in claim 33 wherein the packaging material contains nylon.

35. A non-aqueous electrochemical cell as claimed in any of claims 25 to 34 wherein the electrolyte solvent contains ethylene carbonate and/or diethyl carbonate.

36. A non-aqueous electrochemical cell as claimed in any of claims 25 to 35 wherein the electrolyte solvent contains propylene carbonate.

37. A non-aqueous electrochemical cell as claimed in any of claims 25 to 36 wherein the cell contains 0.05 to 20% by volume of the unsaturated cyclic carbonate based on the electrolyte solvent.

38. A non-aqueous electrochemical cell as claimed in any of claims 25 to 36 wherein the cell contains 0.5 to 2% by volume of the unsaturated cyclic carbonate based on the electrolyte solvent.

39. A non-aqueous electrochemical cell as claimed in any of claims 25 to 38 wherein the alkali metal is lithium.

40. A non-aqueous electrochemical cell as claimed in claim 39 wherein the positive electrode includes carbon as electrode active material.

41. A non-aqueous electrochemical cell as claimed in claim 40 wherein the carbon is graphite.

42. A non-aqueous electrochemical cell as claimed in any of claims 39 to 41 wherein the negative electrode material contains a lithium transition metal oxide as electrode active material.

43. A non-aqueous electrochemical cell as claimed in claim 42 wherein the lithium transition metal oxide is LiCoO₂, LiNiO₂ or LiMn₂O₄.

44. A non-aqueous electrochemical cell as claimed in any of claims 25 to 43 wherein the unsaturated cyclic carbonate is added to the electrolyte prior to filling the electrolyte into the cell.

45. A non-aqueous electrochemical cell as claimed in any of claims 25 to 43 wherein the electrodes are formed by coating an electrode paste onto a current collector and the unsaturated cyclic carbonate is added to at least one of the electrode pastes prior to coating on the current collector.

46. A non-aqueous electrochemical cell as claimed in claim 45 wherein the electrode paste contains a binder and the unsaturated cyclic carbonate is added to the binder.

47. Use of an unsaturated cyclic carbonate to reduce the concentration of HF generated by reaction of electrolyte salt with residual water in a non-aqueous electrochemical cell comprising a first electrode and a second counterelectrode each capable of reversibly incorporating an alkali metal, an alkali metal incorporated into at least one of said electrodes and an electrolyte comprising at least one salt of the alkali metal and a non-aqueous solvent.

48. Use as claimed in claim 47 wherein the unsaturated cyclic carbonate is a compound of formula (1): 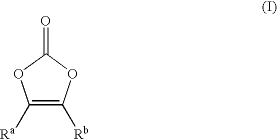
wherein R^{a} and R^{b}, which may be the same or different, are each selected from hydrogen, halogen, amino, substituted amino, amide, carbonate, straight or branched chain saturated or unsaturated aliphatic groups, cyclic aliphatic groups, aromatic groups or heterocyclic groups, where the groups R^{a} and/or R^{b} are carbon containing groups, these groups being optionally substituted.

49. Use as claimed in claim 47 wherein the unsaturated cyclic carbonate is vinylene carbonate.

50 Use as claimed in any of claims 47 to 49 wherein the cell includes an element limiting the temperature at which the cell can be dried.

51. Use as claimed in claim 50 wherein the element is a temperature sensitive separator.

52. Use as claimed in claim 50 wherein the element is a temperature sensitive packaging material.

53. Use as claimed in any of claims 50 to 52 wherein the element limits the temperature at which the cell can be dried to 95° C. or less.

54. Use as claimed in any of claims 50 to 52 wherein the element limits the temperature at which the cell can be dried to 90° C. or less.

55. Use as claimed in any of claims 50 to 52 wherein the element limits the temperature at which the cell can be dried to 60° C. or less.

56. Use as claimed in any of claims 47 to 55 wherein the cell contains a water based binder.

57. Use as claimed in any of claims 47 to 55 wherein the cell contains a packaging material containing a small amount of water.

58. Use as claimed in claim 57 wherein the packaging material contains nylon.

59. Use as claimed in any of claims 47 to 58 wherein the electrolyte solvent contains ethylene carbonate and/or diethyl carbonate.

60. Use as claimed in any of claims 47 to 59 wherein the electrolyte solvent contains propylene carbonate.

61. Use as claimed in any of claims 47 to 60 wherein the cell contains 0.05 to 20% by volume of the unsaturated cyclic carbonate based on the electrolyte solvent.

62. Use as claimed in any of claims 47 to 60 wherein the cell contains 0.5 to 2% by volume of the unsaturated cyclic carbonate based on the electrolyte solvent.

63. Use as claimed in any of claims 47 to 62 wherein the alkali metal is lithium.

64. Use as claimed in claim 63 wherein the positive electrode includes carbon as electrode active material.

65. Use as claimed in claim 64 wherein the carbon is graphite.

66. Use as claimed in any of claims 63 to 66 wherein the negative electrode material contains a lithium transition metal oxide as electrode active material.

67. Use as claimed in claim 66 wherein the lithium transition metal oxide is LiCoO₂, LiNiO₂ or LiMn₂O₄.

68. Use as claimed in any of claims 47 to 67 wherein the unsaturated cyclic carbonate is added to the electrolyte prior to filling the electrolyte into the cell.

69. Use as claimed in any of claims 47 to 67 wherein the electrodes are formed by coating an electrode paste onto a current collector and the unsaturated cyclic carbonate is added to at least one of the electrode pastes prior to coating on the current collector.

70. Use as claimed in claim 69 wherein the electrode paste contains a binder and the unsaturated cyclic carbonate is added to the binder.

71. A method of manufacturing a non-aqueous electrochemical cell, said cell comprising:
a first electrode and a second counterelectrode each capable of reversibly incorporating an alkali metal;
a cell housing containing said electrodes;
an alkali metal incorporated into at least one of said electrodes;
an electrolyte comprising at least one salt of the alkali metal and a non-aqueous solvent; and
an unsaturated cyclic carbonate;
said method comprising the steps of:
(a) assembling said electrodes in said cell housing to form a cell precursor;
(b) drying said cell precursor at a temperature of 95° C. or less;
(c) filling said electrolyte into said cell precursor; and
(d) sealing said housing and initialising said cell.

72. A method as claimed in claim 71 wherein the unsaturated cyclic carbonate is a compound of formula (I): 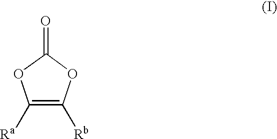
wherein R^{a} and R^{b}, which may be the same or different, are each selected from hydrogen, halogen, amino, substituted amino, amide, carbonate, straight or branched chain saturated or unsaturated aliphatic groups, cyclic aliphatic groups, aromatic groups or heterocyclic groups, where the groups R^{a} and/or R^{b} are carbon containing groups, these groups being optionally substituted.

73. A method as claimed in claim 71 wherein the unsaturated cyclic carbonate is vinylene carbonate.

74. A method as claimed in any of claims 71 to 74 wherein the cell includes an element limiting the temperature at which the cell can be dried.

75. A method as claimed in claim 74 wherein the element is a temperature sensitive separator.

76. A method as claimed in claim 74 wherein the element is a temperature sensitive packaging material.

77. A method as claimed in any of claims 74 to 77 wherein the cell precursor is dried at a temperature of 90° C. or less.

78. A method as claimed in any of claims 74 to 77 wherein the cell precursor is dried at a temperature of 60° C. or less.

79. A method as claimed in any of claims 74 to 78 wherein the cell contains a water based binder.

80. A method as claimed in any of claims 74 to 78 wherein the cell contains a packaging material containing a small amount of water.

81. A method as claimed in claim 80 wherein the packaging material contains nylon.

82. A method as claimed in any of claims 74 to 81 wherein the electrolyte solvent contains ethylene carbonate and/or diethyl carbonate.

83. A method as claimed in any of claims 74 to 82 wherein the electrolyte solvent contains propylene carbonate.

84. A method as claimed in any of claims 74 to 83 wherein the cell contains 0.05 to 20% by volume of the unsaturated cyclic carbonate based on the electrolyte solvent.

85. A method as claimed in any of claims 74 to 83 wherein the cell contains 0.5 to 2% by volume of the unsaturated cyclic carbonate based on the electrolyte solvent.

86. A method as claimed in any of claims 74 to 85 wherein the alkali metal is lithium.

87. A method as claimed in claim 86 wherein the positive electrode includes carbon as electrode active material.

88. A method as claimed in claim 87 wherein the carbon is graphite.

89. A method as claimed in any of claims 86 to 88 wherein the negative electrode material contains a lithium transition metal oxide as electrode active material.

90. A method as claimed in claim 89 wherein the lithium transition metal oxide is LiCoO₂, LiNiO₂ or LiMn₂O₄.

91. A method as claimed in any of claims 74 to 90 wherein the unsaturated cyclic carbonate is added to the electrolyte prior to step (d).

92. A method as claimed in any of claims 74 to 90 wherein the electrodes are formed by coating an electrode paste onto a current collector and the unsaturated cyclic carbonate is added to at least one of the electrode pastes prior to coating on the current collector.

93. A non-aqueous electrochemical cell as claimed in claim 92 wherein the electrode paste contains a binder and the unsaturated cyclic carbonate is added to the binder.
